(19) United States
(12) Patent Application Publication
(10) Pub. No.: US 2016/0083303 A1
(43) Pub. Date: Mar. 24, 2016

(54) ADDITIVE MANUFACTURING OF CERAMIC TURBINE COMPONENTS BY TRANSIENT LIQUID PHASE BONDING USING METAL OR CERAMIC BINDERS

(71) Applicant: United Technologies Corporation, Hartford, CT (US)

(72) Inventors: Sergey Mironets, Charlotte, NC (US); Grant O. Cook, III, Tolland, CT (US)

(73) Assignee: United Technologies Corporation, Hartford, CT (US)

(21) Appl. No.: 14/786,919

(22) PCT Filed: Apr. 22, 2014
(86) PCT No.: PCT/US14/34939

§ 371 Date: Oct. 23, 2015

Related U.S. Application Data
(60) Provisional application No. 61/815,801, filed on Apr. 25, 2013.

(51) Int. Cl. C04B 35/65; C04B 35/44; C04B 35/48; C04B 35/565

(52) U.S. Cl. CPC C04B 35/65; C04B 35/565; C04B 35/44; C04B 35/48; B33Y 70/00

(57) ABSTRACT

A ceramic turbine component is formed by a process including mixing a ceramic powder with an inorganic binder powder. The powder mixture is then formed into a turbine component that is subsequently densified by transient liquid phase sintering. In an embodiment, the turbine component may be formed by an additive manufacturing process such as selective laser sintering.

### BACKGROUND

This invention relates generally to the field of additive manufacturing. In particular, the invention relates to ceramic turbine components formed by an additive manufacturing process and densified by transient liquid phase bonding using metal or ceramic binders.

Additive manufacturing refers to a category of manufacturing methods characterized by the fact that the finished part is created by a layer-wise construction of a plurality of thin sheets of material identical in shape to equivalent planar cross sections of an exact digital model of the part and stored in the memory of the equipment producing the part. Additive manufacturing may involve applying material by a computer controlled process to a work stage and consolidating the material by thermal processes to create a layer. The process is repeated up to several thousand times to arrive at the final component.

Various types of additive manufacturing are known. Additive manufacturing categories as classified by ASTM include material jetting wherein droplets of build material are selectively deposited, powder bed fusion wherein thermal energy selectively fuses regions of a powder bed, directed energy deposition wherein focused thermal energy melts material during deposition, material extrusion wherein material is selectively dispersed through a nozzle, and others. Typical directed energy sources for the above include laser and electron beams.

Recent trends in additive manufacturing toward direct fabrication of production ready metal and ceramic components have minimized the role polymer binders play in the forming process.

### SUMMARY

A method of forming a component includes preparing a starting powder by mixing a first ceramic powder with an inorganic binder powder. The powder mixture is then formed into a component by an additive manufacturing process. The component is densified by transient liquid phase bonding. In one preferred embodiment, the component may be formed by selective laser sintering. In another preferred embodiment, the component may be a turbine component.

A method includes forming a component from a mixed powder of a first ceramic powder and an inorganic binder powder by a layer by layer additive manufacturing process. The component is heated during forming and during a post forming treatment to initiate reactions whereby liquid is formed and densification proceeds by transient liquid phase bonding.

### BRIEF DESCRIPTION OF THE DRAWINGS

FIG. 1 is a schematic of a powder based forming process.

FIG. 2 is an additive manufacturing process of the present invention.

### DETAILED DESCRIPTION

Additive manufacturing is a process wherein three dimensional (3D) objects are produced with a layer by layer technique directly from a digital model. The additive manufacturing process is in distinct contrast to conventional subtractive methods of manufacturing wherein material is removed in a piece by piece fashion from a blank by machining, grinding, etc. or by other forming methods such as forging, casting, injection molding, etc. In additive manufacturing, a piece is formed by the deposition of successive layers of material with each layer adhering to the previous layer until the build is completed. A single layer may be formed by sintering, fusing, or otherwise solidifying specific areas of the top surface of a powder bed or a polymerizable liquid by a computer controlled beam of energy or by depositing individual liquid or semi-solid drops of a material on specific areas of a workpiece by a computer controlled deposition apparatus. Common energy sources are laser and electron beams.

Additive manufacturing technology was originally used to form polymer models for design and prototyping. Current additive manufacturing processing now produces product from polymers, metal, metal polymer composites, and ceramics. In addition to pre-production designs, and models, current efforts now include direct additive manufacturing fabrication of production parts for obvious reasons. The direct freeform fabrication of a superalloy turbine component, such as an airfoil with internal cooling passages, for example, can eliminate a number of costly manufacturing operations.

Powder based additive manufacturing processes applicable to the present invention include selective laser sintering (SLS), direct laser sintering (DLS), selective laser melting (SLM), direct laser melting (DLM), electron beam melting (EBM), direct metal deposition, and others known in the art.

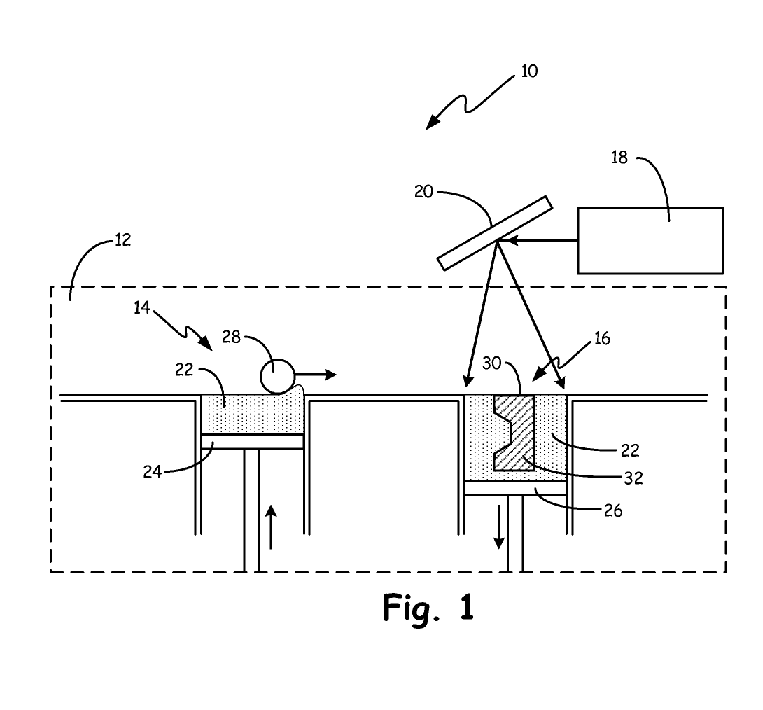

An example of a powder-based additive manufacturing process of the invention is shown in FIG. 1. Process 10 includes manufacturing chamber 12 containing devices that produce solid freeform objects by additive manufacturing. An example of process 10 is selective laser sintering (SLS). SLS process 10 comprises powder storage chamber 14, build chamber 16, laser 18, and scanning minor 20. During operation of SLS process 10, powder 22 is fed upward by piston 24 and is spread over build platform 26 by roller 28. After powder 22 is spread in an even layer on build platform 26, laser 18 and scanning minor 20 are activated to direct a laser beam over build platform 26 to sinter selective areas of powder 22 to form a single layer 30 of solid freeform object 32 and to attach the sintered areas to underlying platform 26 according to a 3D computer model of object 32 stored in an STL memory file in process 10. In the next step, roller 28 is returned to a starting position, piston 24 advances to expose another layer of powder 22 and build platform 26 indexes down by one layer thickness. Roller 28 then spreads a layer of powder 22 over the surface of build platform 26 containing selectively sintered areas. Laser 18 and scanning mirror 20 are activated and selective areas of the deposited layer of powder are again sintered and joined to the underlying layer according to the cross section of the digital model of the component stored in the memory of process 10. The process is repeated until solid freeform part 32 is completed. As mentioned, process 10 is only an example of a solid freeform manufacturing process and is not meant to limit the invention to any single process known in the art.

Chamber 12 of process 10 provides a controlled build environment including inert gases or vacuum. Layer thickness depends on powder size and may range from 20 microns to over a millimeter. Powder 22 may be spread on build platform 26 by roller 28 or another spreading means, such as a scraper.

Other systems, such as direct metal deposition are used in the art wherein material is added bit by bit, according to a controlled distribution process driven by a 3D computer model stored in memory in the deposition equipment. Metal and ceramic powders can be deposited in paste form and metals can be deposited in molten or semi-molten form, and by other deposition processes known in the art. Examples of additive manufacturing processes include, but are not limited to, selective laser sintering (SLS), direct laser sintering (DLS), selective laser melting (SLM), direct laser melting (DLM), laser engineered net shaping (LENS), electron beam melting (EBM), direct metal deposition, and others known in the art.

Polymer binders can aid in adhering powder particles together before, during, and after additive manufacturing. The binder, in powder form, can be mixed with the metal or ceramic starting powder or the starting powders can be coated with a polymer binder. Metal or ceramic parts produced by additive manufacturing wherein a polymer binder is used to improve particle adhesion are usually subjected to a burn out treatment to eliminate the binder from the microstructure before a part is put in service. The polymer may also interfere with particle to particle adhesion during sintering.

Suitable binder systems for the additive manufacturing of sintered ceramic parts of the invention include metal and ceramic binders. Dimensional control and particle adhesion during sintering are improved when a liquid phase is present. Liquid phase sintering is a process that provides densification and interparticle cohesion to occur while the liquid phase solidifies or is otherwise consumed in the sintering process. The sintered product may exhibit low porosity and acceptable structural integrity.

Many multi-component material systems exist wherein one or more components react during sintering to form a liquid that both enhances densification and dimensional stability. Specific examples are when eutectic or peritectic reactions are present in the compositional range of the reactants at a processing temperature of interest. The liquid may be consumed in the process by the surrounding matrix or may solidify by combining with the components to form solid solutions, additional intermetallic or ceramic solid phases, by evaporating, or by other means known in the art. This process is termed transient liquid phase bonding (TLPB). In transient liquid phase bonding, the binder material and ceramic material react with each other and by diffusion of the binder system into the first ceramic or by other means to form a liquid phase. The liquid phase preferably solidifies isothermally.

It is a purpose of this invention to fabricate freeform ceramic turbine components using laser or electron beam driven additive manufacturing processing using metal, ceramic, and metal/ceramic binder systems. The binder systems are selected to allow sintering and densification to occur preferably by transient liquid phase bonding by eutectic, peritectic, or other intercomponent thermal reactions.

Candidate metal binder systems naturally depend on the ceramic component. In general, a candidate binder material may be a material that reacts with the ceramic during sintering to form a lower melting phase that wets the ceramic. This process may exist in material systems at compositions where eutectic or peritectic reactions occur. Candidate ceramic materials include at least oxides, nitrides, carbides, oxynitrides, carbonitrides, lanthanides, and mixtures thereof.

Candidate material systems conforming to the above criteria are reported in “Overview of Transient Liquid Phase and Partial Transient Liquid Phase Bonding”, J. Mater. Sci. 46, 5305 (2011) by one of the inventors and incorporated by reference in entirety herein. Example ceramic systems with transient liquid phase binder additions are shown in the following table.

Ceramic Systems with Transient Liquid Phase Binder Constituents

| | Transient Liquid Phase |
|---|---|
| Ceramic | Binder Constituents |
| SiC | Al₂O₃, rare earth oxides, SiO₂ |
| SiC | AlN, rare earth oxides |
| SiC | Ge |
| Si₃N₄ | BN |
| Si₃N₄ | Oxynitride glass |
| Si₃N₄—Y₂O₃—AlN | HfO |
| 3Y-TZP (yttria-doped polycrystalline | CuO |
| tetragonal zirconia) | |
| Al₂O₃ | Al, SiO₂ |
| Al₂O₃ | AlN, ZrO₂ |
| Al₂O₃ | Al |
| Al₂O₃ | B₂O₃ |
| YAG (yttrium aluminum garnet) | AlN |
| TiO₂ | Bi₂O₃ |

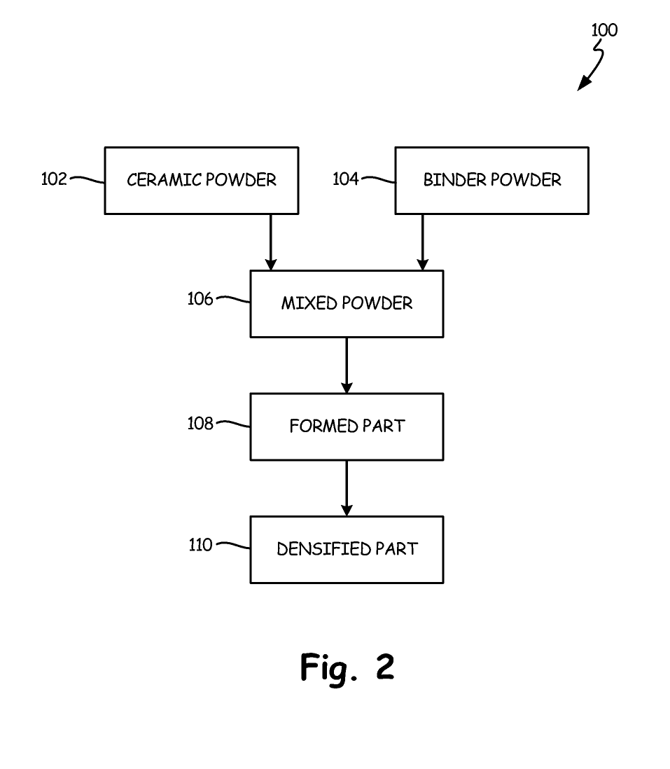

Powder based additive manufacturing process 100 of the present invention is schematically shown in FIG. 2. In the process, ceramic powder 102 and binder powder 104 are mixed to form starting composition 106. Binder powder 104 may be a metal or ceramic powder, or mixtures thereof. Binder powder 104 may be chosen such that when mixed with ceramic powder 102 and heated to a sintering temperature, binder powder 104 will melt to form a liquid phase or will alloy or otherwise react with ceramic powder 102 to form a lower temperature molten phase that may wet the ceramic powder.

After ceramic powder 102 and binder powder 104 are mixed to form mixed powder 106 starting material, for example, for additive manufacturing process 10, the starting material is formed into freeform part 30 (Step 108). Additive manufacturing process 10, used for forming, may be at least one of direct laser sintering, direct laser melting, selective laser sintering, selective laser melting, laser engineered net shaping, or electron beam melting. Other methods known in the art, such as direct metal deposition may also be employed. During forming by an additive manufacturing process of the invention, the part may densify by transient liquid phase bonding.

Following forming, the additive manufactured freeform part may be densified further by transient liquid phase sintering in air, a controlled atmosphere, or in a vacuum (Step 110). A common feature of transient liquid phase sintering is isothermal densification while the liquid phase is absorbed by the matrix, solidified by precipitation of ceramic or intermetallic phases or is evaporated.

In an embodiment, aluminum oxide (Al₂O₃) freeform parts are formed and densified by transient liquid phase sintering with Al and silica (SiO₂), AlN and zirconia (ZrO₂), or B₂O₃ binder systems.

In another embodiment, silicon nitride (Si₃N₄) freeform parts are formed and densified by transient liquid phase sintering with BN or oxynitride glass binder systems.

In still another embodiment, silicon carbide (SiC) freeform parts are formed and densified by transient liquid phase sintering with alumina (Al₂O₃), rare earth oxides, and silica (SiO₂) binder systems.

### EXAMPLE 1

A sintered silicon carbide body can be formed from a mixture of 82-99% by weight of silicon carbide and about 0.5-10% by weight of nitrogen containing aluminum compounds, such as aluminum nitride and others known in the art, by transient liquid phase sintering as described in U.S. Pat. No. 5,298,470 to Chia et al. and incorporated herein in entirety. Densities of greater than 90% of theoretical were achieved at sintering temperatures of about 1850-1900° C.

### EXAMPLE 2

Transparent yttrium-aluminum garnet material (Y₃Al₅O₁₂:YAG) can be transient liquid phase sintered to transparency from a mixture of yttria (Y₂O₃) and alumina (Al₂O₃) by the addition of aluminum nitride (AlN) as a sintering aid as described by EP 1433764 to Niimi et al. and incorporated in entirety. Sintering occurred at 1600-1900° C. under a reducing atmosphere.

### EXAMPLE 3

Mullite zirconia (ZrO₂) composites have been shown to form by transient liquid phase sintering from mixtures of alumina (Al₂O₃), zircon (ZrSiO₄), and ceria (CeO₂) at sintering temperatures of 1450° C. to 1600° C. by Garrido et al., Mat. Sci. Eng. A369 (2004) 250 and incorporated herein in entirety.

### Discussion of Possible Embodiments

The following are non-exclusive descriptions of possible embodiments of the present invention.

A method of forming a component includes preparing a starting powder by mixing a first ceramic powder with an inorganic binder powder; forming the mixed powder into a component by an additive manufacturing process; and densifying the component by transient liquid phase sintering.

The system of the preceding paragraph can optionally include, additionally, and/or alternatively, any, one or more of the following features, configurations, and/or additional components:

The densification may occur during forming and during a post forming treatment.

The transient liquid phase may be formed by a reaction between the first ceramic powder and binder powder that solidifies.

The solidification of the transient liquid phase may be an isothermal process.

The inorganic binder powder may include a metal, an intermetallic compound, a ceramic, or mixtures thereof.

The first ceramic may comprise oxides, nitrides, carbides, oxynitrides, carbonitrides, lanthanides, or mixtures thereof.

The additive manufacturing process may comprise at least one of selective laser sintering, direct laser sintering, selective laser melting, direct laser melting, laser engineered net shaping, electron beam melting, and direct metal deposition.

The component may be a turbine component.

The first ceramic powder may be SiC and the inorganic binder powder may be Al₂O₃+rare earth oxides+SiO₂, AlN+rare earth oxides, or Ge.

The first ceramic powder may be Si₃N₄ and the inorganic binder powder may be BN or oxynitride glass.

The first ceramic powder may be Si₃N₄—Y₂O₃—AlN and the inorganic binder powder may be HfO.

The first ceramic powder may be 3Y-TZP (yttria-doped polycrystalline tetragonal zirconia) and the inorganic binder powder may be CuO.

The first ceramic powder may be Al₂O₃ and the inorganic binder powder may be Al+SiO₂, AlN+ZrO₂, Al, or B₂O₃.

The first ceramic powder may be YAG (yttrium aluminum garnet) and the inorganic binder powder may be AlN.

The first ceramic powder may be TiO₂ and the inorganic binder powder may be Bi₂O₃.

A method of forming a component includes forming the component from a mixed powder of a first ceramic powder and an inorganic binder powder by a layer by layer additive manufacturing process; and heating the component to initiate reactions whereby liquid is formed that initiates densification of the component by transient liquid phase sintering.

The method of the preceding paragraph can optionally include, additionally, and/or alternatively, any, one or more of the following features, configurations, and/or additional components.

The transient liquid phase may form by a reaction between the first ceramic powder and binder powder and solidify.

The solidification of the liquid phase may be an isothermal process.

The binder powder material may be at least one of a metal, an intermetallic compound, a ceramic, or mixtures thereof.

The first ceramic powder may include oxides, nitrides, carbides, oxynitrides, carbonitrides, lanthanides, and mixtures thereof.

The transient liquid phases may form by direct melting of the binder or by interparticle diffusion or alloying to form eutectic, peritectic, or other lower temperature melting phases.

The additive manufacturing process may include at least one of selective laser sintering, direct laser sintering, selective laser melting, direct laser melting, laser engineered net shaping, electron beam melting, and direct metal deposition.

Although the present invention has been described with reference to preferred embodiments, workers skilled in the art will recognize that changes may be made in form and detail without departing from the spirit and scope of the invention.

1. A method of forming a component comprising:
preparing a starting powder by mixing a first ceramic powder with an inorganic binder powder;
forming the mixed powder into a component by an additive manufacturing process; and
densifying the component by transient liquid phase sintering.

2. The method of claim 1, wherein densifying may occur during forming and during a post forming treatment.

3. The method of claim 1, wherein a transient liquid phase is formed by a reaction between the first ceramic powder and the binder powder, that solidifies.

4. The method of claim 3, wherein solidification of the transient liquid phase is an isothermal process.

5. The method of claim 1, wherein the inorganic binder powder material comprises at least one of a metal, an intermetallic compound, a ceramic, or mixtures thereof.

6. The method of claim 1, wherein first ceramic is from the group consisting of oxides, nitrides, carbides, oxynitrides, carbonitrides, lanthanides, and mixtures thereof.

7. The method of claim 1, wherein the additive manufacturing process comprises at least one of selective laser sintering, direct laser sintering, selective laser melting, direct laser melting, laser engineered net shaping, electron beam melting, and direct metal deposition.

8. The method of claim 1, wherein component is a turbine component.

9. The method of claim 1, wherein the first ceramic powder is SiC, and the inorganic binder powder is selected from the group consisting of Al₂O₃+rare earth oxides+SiO₂, AlN+rare earth oxides, and Ge.

10. The method of claim 1, wherein the first ceramic powder is Si₃N₄ and the inorganic binder powder is selected from the group consisting of BN and oxynitride glass.

11. The method of claim 1, wherein the first ceramic powder is Si₃N₄—Y₂O₃—AlN and the inorganic binder powder is HfO.

12. The method of claim 1, wherein the first ceramic powder is 3Y-TZP (yttria doped polycrystalline tetragonal zirconia) and the inorganic binder powder is CuO.

13. The method of claim 1, wherein the first ceramic powder is Al₂O₃ and the inorganic binder powder is selected from the group consisting of Al+SiO₂, AlN+ZrO₂, Al, and B₂O₃.

14. The method of claim 1, wherein the first ceramic powder is YAG (yttrium aluminum garnet) and the inorganic binder powder is MN.

15. The method of claim 1, wherein the first ceramic powder is TiO₂ and the inorganic binder powder is Bi₂O₃.

16. A method of forming a component comprising:
forming the component from a mixed powder of a first ceramic powder and an inorganic binder powder by a layer by layer additive manufacturing process; and
heating the component to initiate reactions whereby liquid is formed that initiates densification of the component by transient liquid phase sintering.

17. The method of claim 16, wherein a transient liquid phase is formed by a reaction between the first ceramic powder and the binder powder and solidifies.

18. The method of claim 17, wherein solidification of the liquid phase is an isothermal process.

19. The method of claim 16, wherein the binder powder material comprises at least one of a metal, an intermetallic compound, a ceramic, or mixtures thereof.

20. The method of claim 16, wherein first ceramic powder is selected from the group consisting of oxides, nitrides, carbides, oxynitrides, carbonitrides, lanthanides, and mixtures thereof.

21. The method of claim 17, wherein transient liquid phases are formed by direct melting of the binder, or by interparticle diffusion or alloying to form eutectic, peritectic, or other lower temperature melting phases.

22. The method of claim 16, wherein the additive manufacturing process comprises at least one of selective laser sintering, direct laser sintering, selective laser melting, direct laser melting, laser engineered net shaping, electron beam melting, and direct metal deposition.
